(19) United States
(12) Patent Application Publication
(10) Pub. No.: US 2002/0045396 A1
(43) Pub. Date: Apr. 18, 2002

(54) Method of fabricating plasma display panel using laser process

(75) Inventor: Steven Kim, Harrington Park, NJ (US)

Correspondence Address: MORGAN LEWIS & BOCKIUS LLP, 1111 PENNSYLVANIA AVENUE NW, WASHINGTON, DC, 20004, US

(73) Assignee: Plasmion Displays, LLC

(21) Appl. No.: 09/969,878

(22) Filed: Oct. 4, 2001

Related U.S. Application Data
(60) Provisional application No. 60/237,388, filed on Oct. 4, 2000.

(51) Int. Cl. H01J 9/24

(52) U.S. Cl. 445/24

(57) ABSTRACT

The present invention relates to a plasma display panel and more particularly to a method of fabricating plasma display panels using a laser process. The method of fabricating a plasma display panel includes forming a first dielectric layer on a substrate, forming a second dielectric layer on the first dielectric layer, and forming at least one capillary in the second dielectric layer and a protection layer on a portion of the second dielectric layer where the capillary is formed.

This application claims the benefit of U.S. Patent Provisional Application No. 60/237,388 filed Oct. 4, 2000, which is hereby incorporated by reference.

### BACKGROUND OF THE INVENTION

Field of the Invention

The present invention relates to a plasma display panel and more particularly to a method of fabricating plasma display panel using a laser process. Although the present invention is suitable for a wide scope of application, it is particularly suitable for simplifying a process for fabricating a plasma display panel as well as reducing a fabrication cost.

### SUMMARY OF THE INVENTION

The present invention is directed to a method of fabricating a plasma display panel that substantially obviates one or more of the problems due to limitations and disadvantages of the related art.

Additional features and advantages of the invention will be set forth in the description, which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of fabricating a plasma display panel includes forming a first dielectric layer on a substrate, forming a second dielectric layer on the first dielectric layer, and forming at least one capillary in the second dielectric layer, and a protection layer on a portion of the second dielectric layer where the capillary is formed therein in one step.

In another aspect of the invention, the method of fabricating a plasma display panel having a substrate includes forming at least one capillary by laser ablation, thereby forming the at least one capillary in the first dielectric layer and vaporizing a portion of the second dielectric layer forming the protection layer.

In another aspect of the invention, the method of fabricating a plasma display panel having a substrate includes carrying out the laser ablation by using a plurality of lasers.

In another aspect of the invention, the method of fabricating a plasma display panel includes a second dielectric layer formed of magnesium (Mg).

In another aspect of the invention, the method of fabricating a plasma display panel having a substrate, includes forming the at least one capillary in the second dielectric layer and a protection layer on a portion of the second dielectric layer under an oxygen environment.

In a further aspect of the invention, the method of fabricating a plasma display panel having a substrate includes, forming the protection layer by a reaction between the vaporized second dielectric layer and an oxygen gas.

Another aspect of the invention includes forming the protection layer of magnesium oxide (MgO).

Another aspect of the invention includes the step of detecting a vaporized second dielectric layer to control the vaporized amount of the second dielectric layer.

Another aspect of the invention includes the step of detecting a vaporized second dielectric layer is performed by using a photospectrum analyzer.

In another aspect of the invention, the method of fabricating a plasma display panel having a substrate includes heating the substrate above a room temperature.

In another aspect of the invention, the method of fabricating a plasma display panel having a substrate includes heating the substrate using a heating pad.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

FIG. 1 is a schematic view illustrating the entire structure of a laser process system according to the present invention;

FIGS. 2A and 2B are schematic views of a method of fabricating the plasma display panel device according to the present invention;

FIG. 3 is a schematic view illustrating a laser and laser optics according to the present invention; and

FIG. 4 is a cross-sectional view illustrating a heating pad used to control a process temperature.

### DETAILED DESCRIPTION OF THE PREFERRED EMBODIMENTS

Reference will now be made in detail to the preferred embodiments of the present invention, examples of which are illustrated in the accompanying drawings.

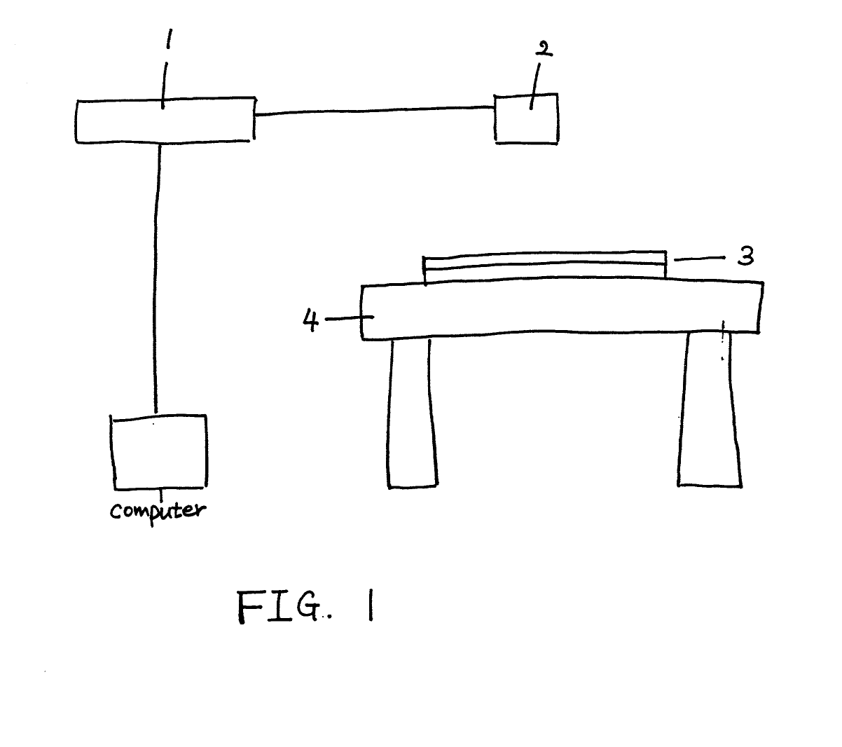

FIG. 1 illustrates a schematic view illustrating the entire structure of a laser process system for fabricating a plasma display panel according to the present invention.

As shown in FIG. 1, plasma display panel (not shown) is positioned on an X-Y-Z translator stage 3, so that the plasma display panel can be placed in desired positions in three dimensions. The X-Y-Z translator stage 3 is further secured on an optical table 4 in order to reduce vibration generated from the surroundings. Above the X-Y-Z translator stage 3, there is a laser optics 2 connected to laser 1 (also shown in FIG. 3).

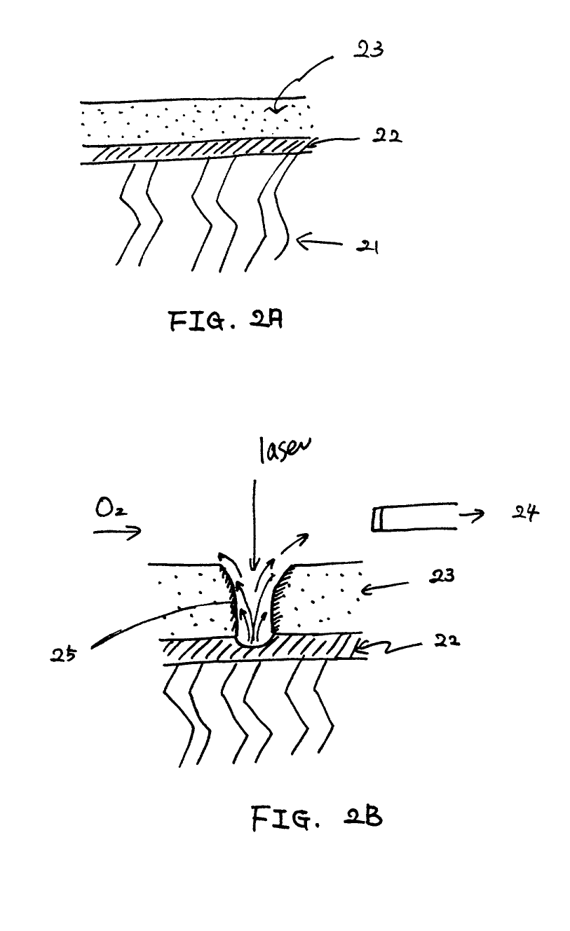

A method of fabricating a plasma display panel (PDP) according to the present invention is now explained. As an example, a method of fabricating a plasma display panel of the present invention is described with reference to FIGS. 2A and 2B.

As shown in FIG. 2A, a layer of magnesium (Mg) 22 is formed between PbO layer 23 and a glass substrate 21. Then, by using a laser, the PbO layer 23 is drilled to form a capillary thereof and magnesium layer 22 is vaporized. A photospectrum analyzer 24 controls this process. Once a capillary is completed in the PbO layer, the photospectrum analyzer 24 will sense a magnesium peak as soon as the laser hits the Mg layer 22 and the Mg is evaporated. In this embodiment, the process is carried out under an oxygen environment. Once the laser vaporizes the magnesium, the magnesium reacts with the oxygen forming MgO films. Then, the MgO films are deposited on a portion of the PbO layer 23 where the capillary is formed therein.

A throughput of the process can be increased by using multiple laser heads 32, as shown in FIG. 3. The throughput linearly increases with the number of laser heads.

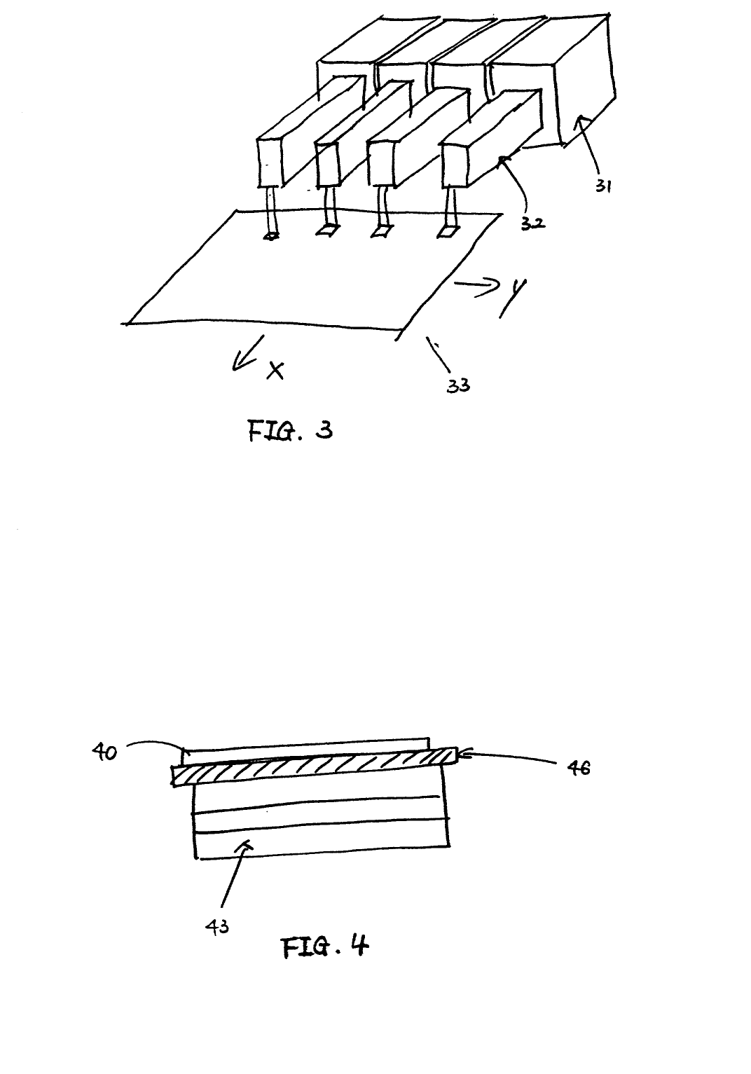

Further, an ablation rate of PbO is also one of the critical elements for increasing a throughput. Erosion of PbO can be increased with a higher temperature. By heating the substrate 40 above room temperature, using a heating pad 46, a drilling rate and eventually an overall throughput are substantially increased, as shown in FIG. 4.

It will be apparent to those skilled in the art that various modifications and variations can be made in a plasma display panel device and method of fabricating the same of the present invention without departing from the spirit or scope of the invention.

Thus, it is intended that the present invention covers the modifications and variations of this invention provided they come within the scope of the appended claims and their equivalents.

What is claimed is:

1. A method of fabricating a plasma display panel having a substrate, comprising:
forming a first dielectric layer on the substrate;
forming a second dielectric layer on the first dielectric layer; and
forming at least one capillary in the second dielectric layer and a protection layer on a portion of the second dielectric layer where the capillary is formed therein in one step.

2. The method according to claim 1, wherein the step of forming the at least one capillary is carried out by laser ablation, thereby forming the at least one capillary in the first dielectric layer and vaporizing a portion of the second dielectric layer forming the protection layer.

3. The method according to claim 2, wherein the laser ablation is carried out using a plurality of lasers.

4. The method according to claim 1, wherein the second dielectric layer is formed of magnesium (Mg).

5. The method according to claim 1, wherein the step of forming the at least one capillary in the second dielectric layer and a protection layer on a portion of the second dielectric layer is performed under an oxygen environment.

6. The method according to claim 2, wherein the protection layer is formed by a reaction between the vaporized second dielectric layer and an oxygen gas.

7. The method according to claim 6, wherein the protection layer is formed of magnesium oxide (MgO).

8. The method according to claim 1, further comprising the step of detecting a vaporized second dielectric layer to control the vaporized amount of the second dielectric layer.

9. The method according to claim 8, wherein the step of detecting a vaporized second dielectric layer is performed by using a photospectrum analyzer.

10. The method according to claim 1, wherein the substrate is heated above a room temperature.

11. The method according to claim 1, wherein the substrate is heated using a heating pad.
